(19) United States
(12) Patent Application Publication
(10) Pub. No.: US 2024/0097476 A1
(43) Pub. Date: Mar. 21, 2024

(54) Charging Method of Battery Pack, Management Method of Storage System, Management Apparatus of Battery Pack, Storage System, and Non-Transitory Storage Medium

(71) Applicant: KABUSHIKI KAISHA TOSHIBA, Tokyo (JP)

(72) Inventors: Keigo HOSHINA, Yokohama Kanagawa (JP); Hayato SEKI, Kawasaki Kanagawa (JP); Shinsuke MATSUNO, Tokyo (JP); Norio TAKAMI, Yokohama Kanagawa (JP)

(73) Assignee: KABUSHIKI KAISHA TOSHIBA, Tokyo (JP)

(21) Appl. No.: 18/175,616

(22) Filed: Feb. 28, 2023

(30) Foreign Application Priority Data
Sep. 16, 2022 (JP) 2022-148150

(51) Int. Cl. H02J 7/00; H01M 10/42; H01M 10/44

(52) U.S. Cl. CPC H02J 7/007182; H01M 10/4257; H01M 10/441; H02J 7/0014; H02J 7/0047; H01M 2010/4271; H01M 2300/0002

(57) ABSTRACT

In one embodiment, there is provided a charging method of a battery pack in which a plurality of aqueous battery cells are electrically connected in series. In this charging method, in a case where the battery pack reaches a reference voltage by a constant-current charging at a first charging rate, constant-current charging is performed on the battery pack at the second charging rate lower than the first charging rate and being from 0.01 C or more to 0.05 C or less. Then, this constant-current charging at the second charging rate is continued until a charged electric charge amount from a start timing of the constant-current charging at the second charging rate reaches a reference electric charge amount set from 1% or more to 5% or less of the nominal capacity of the battery pack.

### CROSS-REFERENCE TO RELATED APPLICATIONS

This application is based upon and claims the benefit of priority from prior Japanese Patent Application No. 2022-148150, filed Sep. 16, 2022; the entire contents of which are incorporated herein by reference.

### FIELD

Embodiments described herein relate generally to a charging method of a battery pack, a management method of a storage system, a management apparatus of a battery pack, a storage system, and a non-transitory storage medium.

### BACKGROUND

A battery pack in which a plurality of aqueous battery cells are electrically connected in series is used as a battery pack to be mounted in a battery-mounted apparatus such as a smartphone, a vehicle, a stationary power supply apparatus, a robot, and a drone. In a battery pack like this, the plurality of aqueous battery cells include a positive electrode, a negative electrode, and an aqueous electrolyte, and an aqueous electrolytic solution obtained by dissolving electrolyte salt in an aqueous solvent is used as the aqueous electrolyte. Also, in a case where this battery pack is repetitively charged and discharged, SOC variation increases between the plurality of aqueous battery cells forming the battery pack. If the SOC variation is produced, this variation increases or the variation is maintained although it does not increase. For example, if the SOC variation is from 1% to 10%, a battery pack taking account of this SOC variation may additionally be installed, so design is performed by taking this SOC variation into consideration. Also, the SOC variation has influence on deterioration of the battery pack itself, that is, the battery pack tends to deteriorate if the SOC variation is produced. In the battery pack, therefore, the SOC variation is corrected between the plurality of aqueous battery cells.

In one SOC variation correcting method, while the voltage of each of the plurality of aqueous battery cells is monitored, only a low-voltage aqueous battery cell equivalent to a low-SOC aqueous battery cell is charged among the plurality of aqueous battery cells forming the battery pack. This equalizes the SOCs of the plurality of aqueous battery cells forming the battery pack. In another SOC variation correcting method, the upper-limit voltage or a voltage close to the upper-limit voltage of a battery pack is set as a reference voltage, the battery pack is charged to this reference voltage, and constant-voltage charging is performed on the battery pack in a state in which the voltage of the battery pack is maintained at the reference voltage. Since constant-voltage charging is performed on the battery pack, electrolysis of water occurs in an aqueous battery cell having a high SOC among a plurality of aqueous battery cells forming the battery pack, so an aqueous battery cell having a low SOC is charged. This equalizes the SOCs of the plurality of aqueous battery cells forming the battery pack.

In the storage system in which the SOC variation between the plurality of aqueous battery cells in the battery pack is corrected as described above, it is required to simplify the system configuration by, e.g., correcting the SOC variation without monitoring the voltage of each aqueous battery cell. It is also required in the battery pack to reduce the amount of a gas generated by electrolysis of water and suppress deterioration of the aqueous battery cell, by reducing a charged electric charge amount to be input to the battery pack when correcting the SOC variation.

### BRIEF DESCRIPTION OF THE DRAWINGS

FIG. 1 is a schematic view showing an example of a storage system according to an embodiment.

FIG. 2 is a schematic view showing an example of an aqueous battery cell forming a battery pack according to the embodiment.

FIG. 3 is a flowchart schematically showing a process of correcting an SOC variation between a plurality of aqueous battery cells in a given battery pack, which is performed by a control unit of a management apparatus in the storage system according to the embodiment.

FIG. 4 is a flowchart schematically showing an example of a process of determining whether to correct an SOC variation between a plurality of aqueous battery cells in each battery pack, which is performed by the control unit of the management apparatus in the storage system according to the embodiment.

FIG. 5 is a schematic view showing an example of a change with time of an electric current flowing through a battery pack in a case where an SOC variation is corrected between a plurality of aqueous battery cells in the battery pack according to a method (charging method) of a comparative example.

FIG. 6 is a schematic view showing a change in voltage of the battery pack with time in a case where an electric current of the battery pack changes with time as shown in the example of FIG. 5 in the comparative example.

FIG. 7 is a schematic view showing an example of a change with time of an electric current flowing through a battery pack in a case where an SOC variation is corrected between a plurality of aqueous battery cells in the battery pack according to a method (charging method) of the embodiment.

FIG. 8 is a schematic view showing a change in voltage of the battery pack with time in a case where an electric current of the battery pack changes with time as shown in the example of FIG. 7 in the embodiment.

FIG. 9 is a schematic view showing an example of a system including a stationary power supply apparatus according to an application example.

FIG. 10 is a schematic view showing the measurement results of the battery capacity of a 2-series-connection structure, which were obtained after the SOC variation was corrected between two aqueous battery cells in each of Examples 1 to 5 and Comparative Examples 1 to 5 for verification related to the embodiment.

### DETAILED DESCRIPTION

According to one embodiment, there is provided a charging method of a battery pack in which a plurality of aqueous battery cells each including an aqueous electrolyte, a positive electrode, and a negative electrode are electrically connected in series. This charging method charges the battery pack with a constant current at a first charging rate until the voltage of the battery pack becomes a reference voltage, and charges the battery pack with a constant current at a second charging rate that is lower than the first charging rate and is from 0.01 C or more to 0.05 C or less in response to the arrival of the battery pack at the reference voltage by the constant-current charge at the first charging rate. In this charging method, the constant-current charging at the second charging rate is continued until a charged electric charge amount from the start timing of the constant-current charging at the second charging rate reaches a reference electric charge amount set from 1% to 5% of the nominal capacity of the battery pack.

The embodiment and the like will be explained below with reference to the drawings. Note that the measurements of physical quantities such as the battery capacity were performed in an environment at 25° C. unless otherwise specified.

### Embodiment

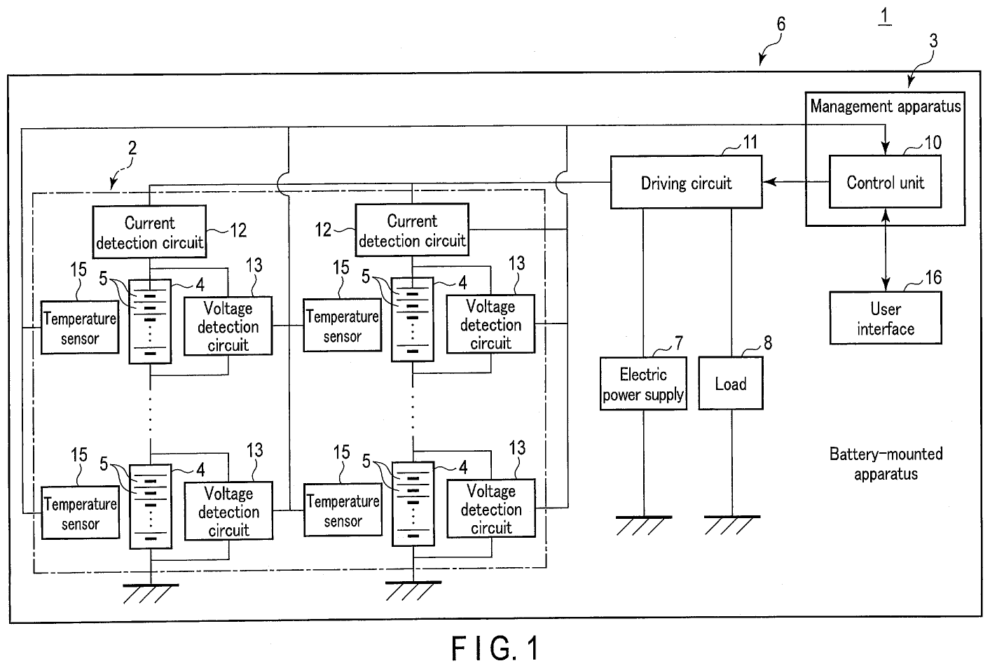

FIG. 1 shows a storage system 1 as an example of a storage system according to an embodiment. As shown in FIG. 1, the storage system 1 includes a storage unit 2 and a management apparatus 3. The storage unit 2 includes one or more battery packs 4. In this example shown in FIG. 1, a plurality of battery packs 4 are installed in the storage unit 2. Each battery pack 4 includes a plurality of aqueous battery cells 5, and the plurality of aqueous battery cells 5 are electrically connected in series in each battery pack 4. The same number of aqueous battery cells 5 are installed in the plurality of battery packs 4, and the number of serially connected aqueous battery cells 5 is the same in the plurality of battery packs 4.

In the example shown in FIG. 1, in the storage unit 2 of the storage system 1, a series connection structure in which the plurality of battery packs 4 are electrically connected in series and a parallel connection structure in which the plurality of battery packs 4 are electrically connected in parallel are formed. Note that the connection structure of the battery packs 4 formed in the storage unit 2 is not particularly limited. For example, in a case where a plurality of battery packs 4 are installed in the storage unit 2, only a series connection structure in which the plurality of battery packs 4 are electrically connected in series can be formed, and a parallel connection structure in which the plurality of battery packs 4 are electrically connected in parallel need not be formed. Alternatively, only a parallel connection structure in which the plurality of battery packs 4 are electrically connected in parallel can be formed, and a series connection structure in which the plurality of battery packs 4 are electrically connected in series need not be formed. In each battery pack 4, the plurality of aqueous battery cells 5 are arranged in a state in which, for example, they are constrained in a housing (not shown).

In the example shown in FIG. 1, the storage unit 2 is mounted in a battery-mounted apparatus 6, and each battery pack 4 is mounted in the battery-mounted apparatus 6. Examples of the battery-mounted apparatus 6 include a smart phone, a vehicle, a stationary power supply device, a robot, a drone, and examples of the vehicle as the battery-mounted apparatus 6 include an electric automobile, a plug-in hybrid electric automobile, and an electric motorcycle. In addition, an example of a robot in which the battery pack 4 is mounted is a transfer robot such as an automated guided vehicle (AGV) used in factories, etc.

Each aqueous battery cell 5 is a single cell (single battery), and is, for example, a battery cell forming a lithium ion secondary battery including an aqueous electrolyte as an electrolyte. Each aqueous battery cell 5 includes an electrode group, and the electrode group includes a positive electrode and a negative electrode. In the electrode group, a separator is interposed between the positive electrode and the negative electrode. The separator is made of a material having electrical insulation properties, and electrically insulates the positive electrode from the negative electrode. The separator is formed to have a thickness from, for example, 1 μm or more to 30 μm or less. Examples of the separator include, but are not limited to, a porous film and a nonwoven fabric, etc., which are made of a synthetic resin. Examples of the synthetic resin forming the porous film and the nonwoven fabric to be used as the separator are polyethylene (PE), polypropylene (PP), cellulose, and polyvinylidene fluoride (PVdF). In addition, in the separator, a nonconductive particle layer may be formed on at least one surface of the porous film or nonwoven fabric, etc. Examples of the nonconductive particles include, but are not limited to, alumina, silica, zirconium, and solid electrolytic particles.

The positive electrode includes a positive electrode current collector such as a positive electrode current collecting foil, and a positive electrode active material-containing layer supported on a surface of the positive electrode current collector. The positive electrode current collector is made of a conductive metal. The positive electrode current collector is, but is not limited to, for example, aluminum, an aluminum alloy, stainless steel, or titanium, and has a thickness of about 10 μm to 30 μm. The positive electrode active material-containing layer includes a positive electrode active material, and may optionally contain a binder and an electro-conductive agent. Examples of the positive electrode active material include, but are not limited to, an oxide, a sulfide, and a polymer, which can occlude and release lithium ions. The positive electrode active material contains, for example, at least one selected from the group consisting of a lithium-manganese composite oxide, a lithium-nickel composite oxide, a lithium-cobalt-aluminum composite oxide, a lithium-nickel-cobalt-manganese composite oxide, a spinel lithium-manganese-nickel composite oxide, a lithium-manganese-cobalt composite oxide, a lithium-iron oxide, lithium fluorinated iron sulfate, a lithium-iron composite phosphate compound, and a lithium-manganese composite phosphate compound.

One or more types of carbonaceous materials are used as the electro-conductive agent. Examples of the carbonaceous materials to be used as the electro-conductive agent are acetylene black, Ketjenblack, graphite, and coke. Also, a polymer resin or the like is used as the binder. The binder contains, for example, at least one selected from the group consisting of polytetrafluoroethylene (PTFE), polyvinylidene fluoride (PVdF), fluorine-based rubber, ethylene-butadiene rubber, polypropylene (PP), polyethylene (PE), carboxymethylcellulose (CMC), polyimide (PI), and polyacrylamide (PAI).

In the positive electrode active material-containing layer, the mixing ratio of the positive electrode active material is preferably from 70% by mass or more to 95% by mass or less, the mixing ratio of the electro-conductive agent is preferably from 3% by mass or more to 20% by mass or less, and the mixing ratio of the binder is preferably from 2% by mass or more to 10% by mass or less. In formation of the positive electrode, a slurry is prepared by suspending the positive electrode active material, electro-conductive agent, and binder in an organic solvent, and the prepared slurry is applied on one or both surfaces of the positive electrode current collector. Then, the applied slurry is dried and rolled by roll press or the like, thereby forming a positive electrode active material-containing layer supported on the one or both surfaces of the positive electrode current collector. In addition, the positive electrode current collector includes a positive electrode current collecting tab as a portion not supporting the positive electrode active material-containing layer.

The negative electrode includes a negative electrode current collector such as a negative electrode current collecting foil, and a negative electrode active material-containing layer supported on a surface of the negative electrode current collector. The negative electrode current collector is made of a conductive metal. The negative electrode current collector is, but is not limited to, for example, zinc, aluminum, an aluminum alloy, or copper, and has a thickness of about 10 μm to 30 μm. The negative electrode active material-containing layer may include a negative electrode active material, and may optionally contain a binder and an electro-conductive agent. Examples of the negative electrode active material include, but are not limited to, an active material which can occlude and release lithium ions, such as a metal oxide, a metal sulfide, a metal nitride, and a carbonaceous material. An example of the metal oxide to be used as the negative electrode active material is a titanium-containing oxide. Then, examples of the titanium-containing oxide to be the negative electrode active material include, for example, a titanium oxide, a lithium titanium-containing composite oxide, a niobium titanium-containing composite oxide, and a sodium niobium titanium-containing composite oxide. Examples of the electro-conductive agent and the binder of the negative electrode active material-containing layer include the same materials as those of the electro-conductive agent and the binder of the positive electrode active material-containing layer.

In the negative electrode active material-containing layer, the mixing ratio of the negative electrode active material is preferably from 70% by mass or more to 95% by mass or less, the mixing ratio of the electro-conductive agent is preferably from 3% by mass or more to 20% by mass or less, and the mixing ratio of the binder is preferably from 2% by mass or more to 10% by mass or less. In formation of the negative electrode, the negative electrode active material-containing layer supported on one or both surfaces of the negative electrode current collector is formed in the same manner as in the formation of the positive electrode. In addition, the negative electrode current collector includes a negative electrode current collecting tab as a portion not supporting the negative electrode active material-containing layer.

In the electrode group, for example, the positive electrode, negative electrode, and separator are wound around a winding axis with the separator sandwiched between the positive electrode active material-containing layer and the negative electrode active material-containing layer, and the electrode group has a wound structure. In another example, the electrode group has a stack structure in which a plurality of positive electrodes and a plurality of negative electrodes are alternately stacked, and a separator is provided between the positive electrode and the negative electrode.

In each aqueous battery cell 5, the electrode group holds (is impregnated with) an aqueous electrolyte. As this aqueous electrolyte, it is possible to use, for example, an aqueous electrolytic solution obtained by dissolving electrolyte salt in an aqueous solvent. As the electrolyte salt to be dissolved in the aqueous solvent, at least one of, for example, lithium salt and sodium salt is used. Examples of the lithium salt to be dissolved in the aqueous solvent are lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis(trifluoro methane sulfonyl)imide) (LiTFSI; LiN(SO₂CF₃)₂), lithium bis(fluorosulfonyl)imide (LiFSI; LiN(SO₂F)₂), and lithium bisoxalate borate (LiBOB; LiB[(OCO)₂]₂).

Examples of the sodium salt to be dissolved in the aqueous solvent are sodium chloride (NaCl), sodium sulfate (Na₂SO₄), sodium hydroxide (NaOH), sodium nitrate (NaNO₃), and sodium trifluoro methane sulfonyl amide (NaTFSA). The molar concentration of lithium ions in the aqueous electrolytic solution is, for example, 3 mol/L or more. The molar concentration of lithium ions in the aqueous electrolytic solution is preferably 6 mol/L or more, and more preferably 12 mol/L or more. A solution containing water is used as the aqueous solvent for dissolving the electrolyte salt. The aqueous solvent can be either pure water or a solvent mixture of water and an organic solvent.

Instead of the aqueous electrolytic solution, it is also possible to use an aqueous gel electrolyte obtained by compositing the aqueous electrolytic solution and a polymer material. Examples of the polymer material to be composited with the aqueous electrolytic solution are polyvinylidene fluoride (PVdF), polyacrylonitrile (PAN), and polyethylene oxide (PEO).

In each aqueous battery cell 5, the electrode group is housed inside a container member. As the container member, any one of a bag-shaped container made of a laminate film and a metal container can be used. Examples of the laminate film include a multilayer film including a plurality of resin layers and a metal layer interposed between the resin layers. The thickness of the laminate film is preferably 0.5 mm or less, and more preferably 0.2 mm or less. The metal container is preferably formed of, for example, at least a kind of metal selected from the group consisting of aluminum, zinc, titanium, and iron, or an alloy thereof. The wall thickness of the metal container is preferably 0.5 mm or less, and more preferably 0.2 mm or less.

In addition, each aqueous battery cell 5 includes a pair of electrode terminals. One of the electrode terminals is a positive electrode terminal electrically connected to the positive electrode current collecting tab, and the other one of the electrode terminals is a negative electrode terminal electrically connected to the negative electrode current collecting tab. The electrode terminal may be an internal terminal formed inside the container member, or an external terminal formed on an outer surface of the container member. The electrode terminal is formed of an electro-conductive material, and is preferably formed of at least a kind of metal selected from the group consisting of aluminum, zinc, titanium, and iron, or an alloy thereof.

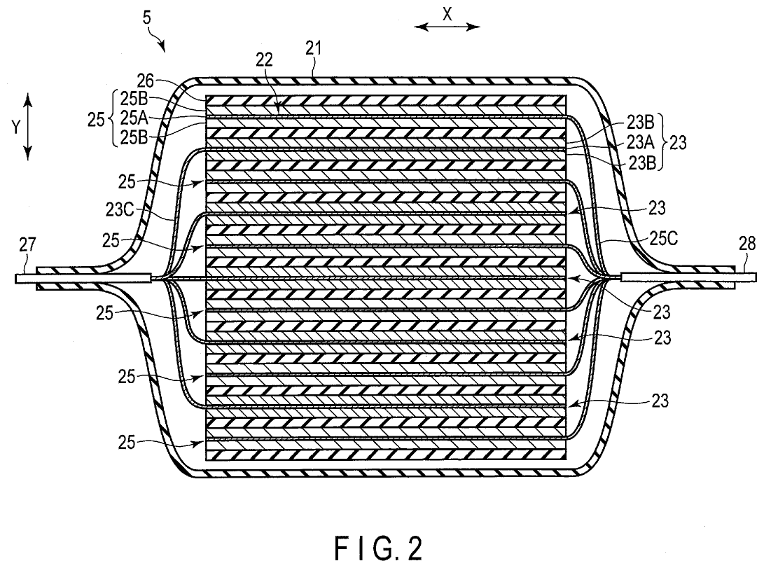

FIG. 2 shows an example of the aqueous battery cell 5. In this example of FIG. 2, in the aqueous battery cell 5, the lengthwise direction (a direction indicated by an arrow X), the widthwise direction (a direction orthogonal or almost orthogonal to the paper surface of FIG. 2) intersecting (orthogonally or almost orthogonally) the lengthwise direction, and the thickness direction (a direction indicated by an arrow Y) intersecting (orthogonally or almost orthogonally) both the lengthwise direction and the widthwise direction are defined. The aqueous battery cell 5 includes a container member 21 and an electrode group 22. The container member 21 is the above-described laminate film. The electrode group 22 is housed inside the container member 21, and the electrode group 22 is impregnated with an aqueous electrolytic solution.

The electrode group 22 has a stack structure in which a plurality of positive electrodes 23 and a plurality of negative electrodes 25 are alternately stacked, and a separator 26 is provided between the positive electrode 23 and the negative electrode 25. The stacking direction of the positive electrodes 23 and the negative electrodes 25 in the electrode group 22 matches or almost matches the thickness direction of the aqueous battery cell 5. In each of the positive electrodes 23, a positive electrode active material-containing layer 23B is supported on both surfaces of a positive electrode current collector 23A, and in each of the negative electrodes 25, a negative electrode active material-containing layer 25B is supported on both surfaces of a negative electrode current collector 25A. In the electrode group 22, a positive electrode current collecting tab 23C as a portion not supporting the positive electrode active material-containing layer 23B in the positive electrode current collector 23A is formed, and the positive electrode current collecting tab 23C protrudes toward one side in the lengthwise direction of the aqueous battery cell 5 with respect to the negative electrode 25 and the separator 26. In the electrode group 22, a negative electrode current collecting tab 25C as a portion not supporting the negative electrode active material-containing layer 25B in the negative electrode current collector 25A is formed, and the negative electrode current collecting tab 25C protrudes to a side opposite to the side to which the positive electrode current collecting tab 23C protrudes, in the lengthwise direction of the aqueous battery cell 5, with respect to the positive electrode 23 and the separator 26.

Further, two openings are formed in the container member 21, and each of the openings is closed by heat-sealing, etc. of the resin layers of the laminate film. A positive electrode terminal 27 is connected to the positive electrode current collecting tab 23C, and the positive electrode terminal 27 is drawn out of the container member 21 from one of the two openings of the container member 21. A negative electrode terminal 28 is connected to the negative electrode current collecting tab 25C, and the negative electrode terminal 28 is drawn out of the container member 21 from the other one of the two openings of the container member 21 which is different from the opening out of which the positive electrode terminal 27 is drawn.

As shown in FIG. 1, an electric power supply 7 and a load 8 are provided in the storage system 1. The power supply 7 can supply electric power to each battery pack 4 of the storage unit 2, and each battery pack 4 is charged by supply of electric power from the electric power supply, etc. Electric power can be supplied to the load 8 from each battery pack 4 of the storage unit 2, and each battery pack 4 is discharged by supply of electric power to the load 8, etc. Examples of the electric power supply 7 include a storage battery different from the storage unit 2, an electric power generator, etc. Examples of the load 8 include an electric motor, a light, etc.

In an example, a motor generator may be provided in the storage system 1. In this case, electric power can be supplied to the motor generator from each battery pack 4 as well as supplied to each battery pack 4 from the motor generator. In other words, the motor generator functions as both an electric power supply and a load. Also, in the example shown in FIG. 1, the electric power supply 7 and the load 8 are mounted in the battery-mounted apparatus 6, but are not limited thereto. Each battery pack 4 of the storage unit 2 may be able to supply electric power to a load outside the battery-mounted apparatus 6. In addition, electric power may be supplied to each battery pack 4 from an electric power supply outside the battery-mounted apparatus 6 including, for example, an electric power supply of a charger.

The management apparatus 3 manages the storage unit 2 including the battery packs 4 by, for example, controlling charging and discharging of each battery pack 4, thereby managing the whole storage system 1. The management apparatus 3 includes a control unit 10 serving as a controller. In the example of FIG. 1, the management apparatus 3 is mounted in the battery-mounted apparatus 6, and forms a processing device (computer) in the battery-mounted apparatus 6. The control unit 10 of the management apparatus 3 includes a processor and a storage medium (non-transitory storage medium). The processor includes any one of a central processing unit (CPU), a graphics processing unit (GPU), an application specific integrated circuit (ASIC), a microcomputer, a field programmable gate array (FPGA), a digital signal processor (DSP), etc. In the storage medium, an auxiliary storage device can be included, in addition to a main storage device such as a memory. Examples of the storage medium include a magnetic disk, an optical disk (CD-ROM, CD-R, DVD, etc.), a magneto-optical disk (MO, etc.), a semiconductor memory, etc.

The control unit 10 may include one or more processors and storage media (non-transitory storage media). In the control unit 10, the processor performs processing by executing a program, etc. stored in the storage medium, etc. In addition, a program executed by the processor of the control unit 10 may be stored in a computer (server) connected through a network, such as the Internet, or a server in a cloud environment, etc. In this case, the processor downloads the program via the network.

In addition, the management apparatus 3 may be provided outside the battery-mounted apparatus 6. In this case, the management apparatus 3 is, for example, a server outside the battery-mounted apparatus 6, and can communicate with a processing device (computer) mounted in the battery-mounted apparatus 6 via the network. Also in this case, the control unit 10 of the management apparatus 3 includes a processor and a storage medium (non-transitory storage medium). In addition, processing of the control unit 10 of the management apparatus 3 may be performed by a processing device mounted in the battery-mounted apparatus 6 and a server (processing device) outside the battery-mounted apparatus 6 in cooperation. In this case, for example, the server, etc. outside the battery-mounted apparatus 6 is a master control device, and the processing device, etc. mounted in the battery-mounted apparatus 6 is a slave control device.

In another example, processing of the control unit 10 of the management apparatus 3 may be performed by a cloud server constructed in a cloud environment. Herein, the infrastructure of the cloud environment is constructed by a virtual processor such as a virtual CPU and a cloud memory. Thus, in a case where the cloud server serves as the control unit 10, processing is performed by the virtual processor, and data necessary for the processing, etc. is stored in the cloud memory. In addition, the processing of the control unit 10 may be performed by a processing device mounted in the battery-mounted apparatus 6 and the cloud server in cooperation. In this case, the processing device (computer) mounted in the battery-mounted apparatus 6 can communicate with the cloud server.

A driving circuit 11 is provided in the storage system 1. The control unit 10 controls driving of the driving circuit 11, thereby controlling supply of electric power to the load 8 from the battery pack 4 of the storage unit 2 as well as supply of electric power to the battery pack 4 of the storage unit 2 from the electric power supply 7. Namely, the control unit 10 controls charging and discharging of each battery pack 4 by controlling the driving of the driving circuit 11. The driving circuit 11 includes a relay circuit that performs switching between output of electric power from the battery pack 4 and input of electric power to the battery pack 4. Further, the driving circuit 11 includes a conversion circuit, and the conversion circuit converts electric power from the electric power supply 7 into direct-current electric power to be supplied to the battery pack 4. The conversion circuit also converts direct-current electric power from the battery pack 4 into electric power to be supplied to the load 8. The conversion circuit can include a voltage transformer circuit, a DC/AC conversion circuit, an AC/DC conversion circuit, etc. In the example of FIG. 1, the driving circuit 11 is mounted in the battery-mounted apparatus 6, but may be formed outside the battery-mounted apparatus 6.

The storage system 1 also includes a current detection circuit 12, a voltage detection circuit 13, and a temperature sensor 15. The current detection circuit 12 detects an electric current flowing through each battery pack 4 in the storage unit 2. In the example shown in FIG. 1, a parallel connection structure in which the plurality of battery packs 4 are electrically connected in parallel is formed in the storage unit 2. Then, current detection circuits 12 equal in number to the parallel connections in the parallel connection structure of the storage unit 2 are installed. Consequently, an electric current of each battery pack 4 can be detected by a corresponding one of the current detection circuits 12. Note that in a case where only one battery pack 4 is installed in the storage unit 2, and in a case where only a series connection structure in which the plurality of battery packs 4 are electrically connected in series is formed in the storage unit 2, an electric current flowing through each of one or more battery packs 4 can be detected by installing only one current detection circuit 12.

One voltage detection circuit 13 is installed for each of one or more battery packs 4, so the storage system 1 includes voltage detection circuits 13 equal in number to the battery packs 4. Each voltage detection circuit 13 detects a voltage to be applied to a corresponding one of the battery packs 4. Consequently, the voltage of each battery pack 4 can be detected by a corresponding one of the voltage detection circuits 13. Note that the storage system 1 does not include a voltage detection circuit or the like that detects the voltage of each of the plurality aqueous battery cells 5 in each battery pack 4. Accordingly, the storage system 1 does not perform, for example, monitoring of the voltage of each aqueous battery cell 5.

In the example shown in FIG. 1, one temperature sensor 15 is installed for each of one or more battery packs 4. In the storage system 1, therefore, the temperature sensors 15 equal in number to the battery packs 4 are installed. Each temperature sensor 15 detects the temperature of a corresponding one of the battery packs 4. Consequently, the temperature of each battery pack 4 can be detected by a corresponding one of the temperature sensors 15. Note that in one example, a temperature sensor detects the temperature in only one place in the storage unit 2 or in an environment in which the storage unit 2 is installed, and the temperature detected by the temperature sensor is used as the temperature of each of the battery packs 4 forming the storage unit 2. In another example, temperature sensors detect the temperatures in a plurality of places in the storage unit 2 or in an environment in which the storage unit 2 is installed, and the average value or the intermediate value of the temperatures detected in the plurality of places is used as the temperature of each of the battery packs 4 forming the storage unit 2.

The control unit 10 of the management apparatus 3 acquires the detection results from the current detection circuit 12, the voltage detection circuit 13, and the temperature sensor 15. Then, the control unit 10 controls charging and discharging of the battery pack 4 based on the current detection result of the current detection circuit 12, the voltage detection result of the voltage detection circuit 13, and the temperature detection result of the temperature sensor 15. The control unit 10 also manages each battery pack 4 based on the detection results of the current detection circuit 12, the voltage detection circuit 13, and the temperature sensor 15.

In addition, in the storage system 1, a user interface 16 is mounted in the battery-mounted apparatus 6. The user interface 16 serves as an operation device on which an operation, etc. is input by a user, etc. of the battery-mounted apparatus 6, as well as a notification device that notifies the user, etc. of the battery-mounted apparatus 6 of information. The user interface 16 includes an input means such as a button, a dial, or a touch panel as an operation device, and the control unit 10 performs processing based on an operation instruction, etc. input by the user interface. In addition, the controller 10 notifies the user, etc. of information, etc. via the user interface 16. The user interface 16 performs notification of information through any one of screen display, sounds, etc. Note that the user interface 16 can also be installed outside the battery-mounted apparatus 6.

Also, the control unit 10 calculates the electric charge amount (charged amount) and the SOC of each battery pack 4 based on the current detection result of each current detection circuit 12. The electric charge amount in real time of each battery pack 4 is calculated based on an electric charge amount at a predetermined time, and on a change with time of an electric current flowing through the battery pack 4 from the predetermined time. For example, the electric charge amount in real time of each battery pack 4 is calculated by adding a time integrated value from a predetermined time of an electric current flowing through the battery pack 4, to the electric charge amount at the predetermined time.

In each battery pack 4, a lower-limit voltage Vlow and an upper-limit voltage Vup are defined in regard to a voltage. In each battery pack 4, a state in which the voltage when discharging or charging is performed under predetermined conditions is the lower-limit voltage Vlow is defined as an SOC 0% state, and a state in which the voltage when discharging or charging is performed under predetermined conditions is the upper-limit voltage Vup is defined as an SOC 100% state. Also, in each battery pack 4, a charging capacity (charged electric charge amount) obtained when the SOC value changes from 0% to 100% by charging under predetermined conditions, or a discharging capacity (discharged electric charge amount) obtained when the SOC value changes from 100% to 0% by discharging under predetermined conditions, is defined as the battery capacity. In addition, the battery capacity of each battery pack 4 can be measured as described earlier when it is used, and the nominal capacity of the battery pack 4 is set as the battery capacity by the manufacturer or the like when it is manufactured. In each battery pack 4, the ratio of the residual electric charge amount (residual capacity) until the SOC 0% state to the battery capacity is the SOC.

In each battery pack 4, the electric charge amount, the SOC, and the battery capacity are defined for each aqueous battery cell 5, in the same manner as that for the battery pack 4. The battery capacity of a series connection portion in which a plurality of battery cells having the same battery capacity are electrically connected in series is the same as or almost the same as the battery capacity of a single battery cell. Also, in each battery pack 4, the battery capacities of a plurality of aqueous battery cells 5 electrically connected in series are the same or almost the same. Therefore, the battery capacity of each battery pack 4 is the same as or almost the same as the battery capacity of each of the aqueous battery cells 5 forming the battery pack 4.

If charging or discharging of the battery packs 4 of the storage unit 2 are repeated in the storage system 1, the SOC variation between the plurality of aqueous battery cells 5 increases. If this SOC variation between the plurality of aqueous battery cells 5 increase in each battery pack 4, the control unit 10 of the management apparatus 3 corrects the SOC variation between the plurality of aqueous battery cells 5 in the battery pack 4. In this embodiment, the control unit 10 corrects the SOC variation between the plurality of aqueous battery cells 5 in each battery pack 4 by controlling charging of the battery pack 4.

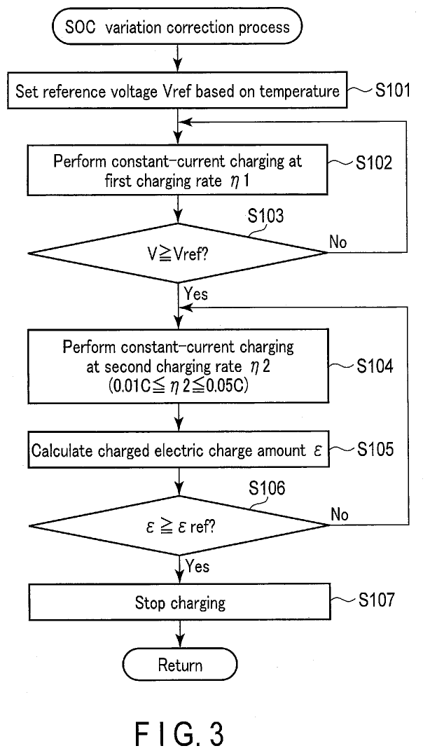

FIG. 3 shows an example of a process of correcting the SOC variation between the plurality of aqueous battery cells 5 in one battery pack 4 by the control unit 10. Note that in other battery packs 4, the SOC variation between the plurality of aqueous battery cells 5 is corrected in the same manner as the process of the example in FIG. 3. When the process of the example in FIG. 3 is started, the control unit 10 sets a reference voltage Vref for the voltage V of the battery pack 4 based on the temperature of the battery pack 4 detected by the temperature sensor 15 (S101).

In one example, the reference voltage Vref is set at a voltage, which is equal to or higher than the voltage of the battery pack 4 in a state in which the SOC is 90% and equal to or lower than the upper-limit voltage Vup of the battery pack 4 (the voltage of the battery pack 4 in a state in which the SOC is 100%). In another example, the reference voltage Vref of the battery pack 4 is set within a range in which a value obtained by subtracting the lower-limit voltage Vlow from the reference voltage Vref is from 90% or more to 100% or less with respect to a value obtained by subtracting the lower-limit voltage Vlow from the upper-limit voltage Vup. In still another example, the reference voltage Vref is set such that a value obtained by dividing the reference voltage Vref by the number of serially connected aqueous battery cells 5 in the battery pack 4 is from 2.40 V or more to 2.75 V or less. Also, the control unit 10 changes the set value of the reference voltage Vref in accordance with the temperature of the battery pack 4. In this case, the control unit 10 decreases the reference voltage Vref as the temperature of the battery pack 4 rises.

Then, the control unit 10 performs constant-current charging of the battery pack 4 at a first charging rate η1 (S102). That is, the battery pack 4 is charged in a state in which the charging current of the battery pack 4 is maintained at the first charging rate η1. The first charging rate η1 is preferably from 0.2 C or more to 1 C or less. The charging rate is defined such that the charged electric charge amount in a case where 1-C charging is performed for 1 hr is the same as the battery capacity of the battery pack 4. Therefore, in a case where the nominal capacity is set at 500 mA·h as the battery capacity of the battery pack 4, 500 mA is 1 C. Then, the control unit 10 determines whether the voltage V of the battery pack 4 is equal to or higher than the reference voltage Vref (S103). If the voltage V is lower than the reference voltage Vref (S103-No), the process returns to S102, and the control unit 10 sequentially performs processing from S102. Accordingly, the constant-current charging of the battery pack 4 at the first charging rate η1 is continued. If the voltage V is equal to or higher than the reference voltage Vref (S103-Yes), the control unit 10 performs constant-current charging of the battery pack 4 at a second charging rate η2 lower than the first charging rate η1 (S104). Therefore, the constant-current charging at the second charging rate η2 is started in response to the arrival of the voltage V of the battery pack 4 at the reference voltage Vref by the constant-current charging at the first charging rate η1. In this case, the battery pack 4 is charged in a state in which the charging current of the battery pack 4 is maintained at the second charging rate η2. The second charging rate η2 is from 0.01 C or more to 0.05 C or less.

Then, the control unit 10 calculates a charged electric charge amount ε from the time at which the constant-current charging at the second charging rate η2 is started (S105). The charged electric charge amount ε can be calculated based on a change with time of the electric current flowing through the battery pack 4 from the time at which the constant-current charging at the second charging rate η2 is started. Subsequently, the control unit 10 determines whether the charged electric charge amount ε from the time at which the constant-current charging at the second charging rate η2 is started is equal to or higher than a reference electric charge amount ε ref (S106). The reference electric charge amount ε ref is set based on the nominal capacity of the battery pack 4, and set from 1% or more to 5% or less of the nominal capacity of the battery pack 4.

If the charged electric charge amount ε is smaller than the reference electric charge amount ε ref (S106-No), the process returns to S104, and the control unit 10 sequentially performs processing from S104. Therefore, the constant-current charging of the battery pack 4 at the second charging rate η2 is continued. On the other hand, if the charged electric charge amount ε is equal to or larger than the reference electric charge amount ε ref (S106-Yes), the control unit 10 stops charging of the battery pack 4 (S107). Consequently, the process of correcting the SOC variation between the plurality of aqueous battery cells 5 is terminated.

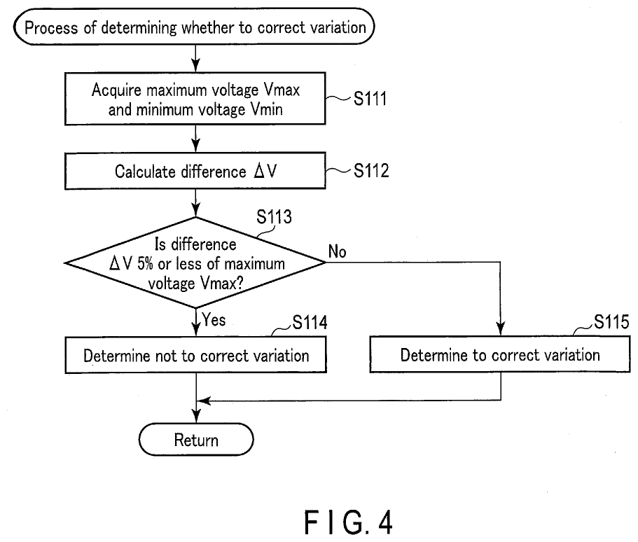

Also, the control unit 10 determines, for each battery pack 4, whether to perform the above-described process of correcting the SOC variation between the plurality of aqueous battery cells 5. FIG. 4 shows an example of the process of determining, for each battery pack 4, whether to perform the process of correcting the SOC variation between the plurality of aqueous battery cells 5, which is performed by the control unit 10. This process of the example shown in FIG. 4 is, for example, periodically performed after the time at which the use of the storage unit 2 and the storage system 1 is started. When the process of the example shown in FIG. 4 is started, the control unit 10 acquires a maximum voltage Vmax that is highest of the voltages of the plurality of battery packs 4 forming the storage unit 2, and a minimum voltage Vmin that is lowest of the voltages of the plurality of battery packs 4 forming the storage unit 2 (S111).

Then, the control unit 10 calculates a difference ΔV between the maximum voltage Vmax and the minimum voltage Vmin (S112). Subsequently, the control unit 10 determines whether the calculated difference ΔV is 5% or less of the maximum voltage Vmax (S113). If the difference ΔV is 5% or less of the maximum voltage Vmax (S113-Yes), the control unit 10 determines not to correct the SOC variation between the plurality of aqueous battery cells 5, for each battery pack 4 (S114). On the other hand, if the difference ΔV is larger than 5% of the maximum voltage Vmax (S113-No), the control unit 10 determines to correct the SOC variation between the plurality of aqueous battery cells 5, for each battery pack 4 (S115).

If the control unit 10 determines to correct the SOC variation, the control unit 10 performs, for example, the process shown in the example of FIG. 4 for each battery pack 4, thereby correcting the SOC variation between the plurality of aqueous battery cells 5. Since each battery pack 4 is charged in accordance with the process of the example shown in FIG. 4, the SOC variation between the plurality of aqueous battery cells 5 is corrected in each battery cell 4, so the SOCs of the plurality of aqueous battery cells 5 are equalized.

Note that in one example, the control unit 10 calculates, for each battery pack 4, an elapsed time from the time at which the use of the storage unit 2 is started, or from the time at which the correction of the SOC variation is performed last time. Then, if the calculated elapsed time exceeds the reference time for each battery pack 4, the control unit 10 performs the process of correcting the SOC variation between the plurality of aqueous battery cells 5.

In another example, the control unit 10 calculates, for each battery pack 4, an integrated value (time integrated value) of the charged electric charge amount from the time at which the use of the storage unit 2 is started, or from the time at which the correction of the SOC variation is performed last time. Then, if the calculated integrated value of the charged electric charge amount exceeds the reference value, the control unit 10 corrects the SOC variation between the plurality of aqueous battery cells 5, for each battery pack 4. Note that it is also possible to determine, for each battery pack 4, whether to correct the SOC variation between the plurality of aqueous battery cells 5, based on the integrated value of the discharged electric charge amount from the time at which the use of the storage unit 2 is started, or from the time at which the correction of the SOC variation is performed last time, instead of the integrated value of the charged electric charge amount. It is further possible to determine, for each battery pack 4, whether to correct the SOC variation between the plurality of aqueous battery cells 5, based on the sum of the above-described integrated value of the charged electric charge amount and the above-described integrated value of the discharged electric charge amount.

In this embodiment as described above, in the battery pack 4 in which the plurality of aqueous battery cells 5 are electrically connected in series, the SOC variation between the plurality of aqueous battery cells 5 is corrected. In this case, constant-current charging is performed on the battery pack 4 at the first charging rate Ill, until the voltage V of the battery pack 4 reaches the reference voltage Vref. In response to the arrival of the battery pack 4 at the reference voltage Vref by the constant-current charging at the first charging rate η1, constant-current charging is performed on the battery pack at the second charging rate η2 that is lower than the first charging rate η1 and is from 0.01 C or more to 0.05 C or less. The constant-current charging at the second charging rate η2 is continued until the charged electric charge amount ε from the time at which the constant-current charging at the second charging rate η2 is started reaches the reference electric charge amount ε ref set from 1% or more to 5% or less of the nominal capacity of the battery pack 4.

Since the SOC variation between the plurality of aqueous battery cells 5 can be corrected with respect to the battery pack 4 as described above, the voltage of each aqueous battery cell 5 is not used in the correction of the SOC variation. In the correction of the SOC variation between the plurality of aqueous battery cells 5, therefore, it is unnecessary to monitor the voltage of each aqueous battery cell 5, and this makes it unnecessary to install, for example, a voltage detection circuit for detecting the voltage of each aqueous battery cell 5. Consequently, the configuration of the storage unit 2 and the system configuration of the storage system 1 can be simplified.

Also, in this embodiment, on the basis of the condition that the charged electric charge amount ε from the start timing of the constant-current charging at the second charging rate η2 reaches the reference electric charge amount ε ref, the constant-current charging of the battery pack 4 at the second charging rate η2 is terminated, and the charging of the battery pack 4 is terminated. Accordingly, in the correction of the SOC variation between the plurality of aqueous battery cells 5, the charged electric charge amount input to the battery pack 4 by the constant-current charging at the second charging rate η2 does not exceed the reference electric charge amount ε ref. Therefore, by setting the reference electric charge amount ε ref from 1% or more to 5% or less of the nominal capacity of the battery pack 4, the charged electric charge amount to be input to the battery pack 4 is appropriately reduced in the correction of the SOC variation between the plurality of aqueous battery cells 5.

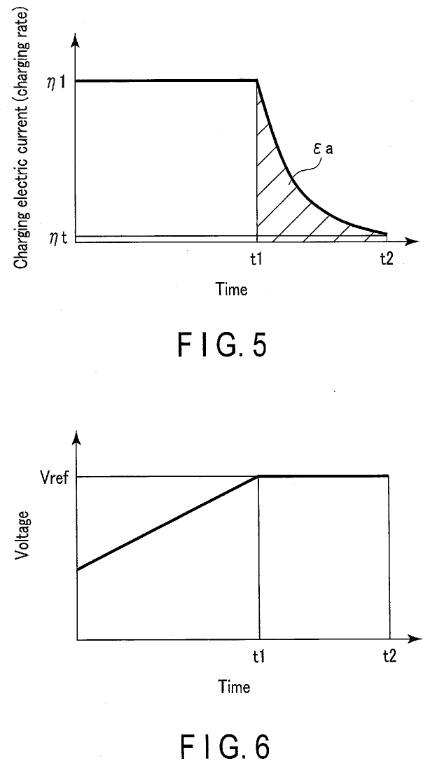

A comparative example in which the SOC variation between the plurality of aqueous battery cells 5 is corrected in the battery pack 4 by a method (charging method) different from the embodiment will be explained below. FIG. 5 shows an example of a change with time of an electric current flowing through the battery pack 4 in a case where the SOC variation between the plurality of aqueous battery cells 5 is corrected in the battery pack 4 by the method (charging method) of the comparative example. FIG. 6 shows a change with time of the voltage of the battery pack 4 in a case where the electric current of the battery pack 4 changes with time as shown in the example of FIG. 5 in the comparative example. In FIGS. 5 and 6, the abscissa indicates the time. Also, the ordinate in FIG. 5 indicates the charging electric current of the battery pack 4 by the charging rate, and the ordinate in FIG. 6 indicates the voltage of the battery pack 4.

In this comparative example as shown in FIGS. 5 and 6, as in the above-described embodiment and the like, in the correction of the SOC variation between the plurality of aqueous battery cells 5, the constant-current charging is performed on the battery pack 4 at the first charging rate η1 until the voltage V of the battery pack 4 reaches the reference voltage Vref. In the comparative example, however, the constant-voltage charging is performed on the battery pack 4 by the reference voltage Vref, in response to the arrival of the voltage V of the battery pack 4 at the reference voltage Vref. In this example shown in FIGS. 5 and 6, the constant-current charging at the first charging rate η1 is switched to the constant-voltage charging by the voltage Vref at time t1.

Then, in the comparative example, in a state in which the constant-voltage charging is performed on the battery pack 4 at the reference voltage Vref, the charging of the battery pack 4 is terminated in a case where the charging electric current of the battery pack 4 reduces to a termination charging rate lit. In the example shown in FIGS. 5 and 6, the charging of the battery pack 4 is terminated at time t2. Also, in the example shown in FIGS. 5 and 6, the charged electric charge amount input to the battery pack 4 during the constant-voltage charging at the reference voltage Vref, that is, the charged electric charge amount input to the battery pack 4 from time t1 to time t2 is an electric charge amount ε a. The electric charge amount ε a is equivalent to the area of an obliquely hatched portion in FIG. 5.

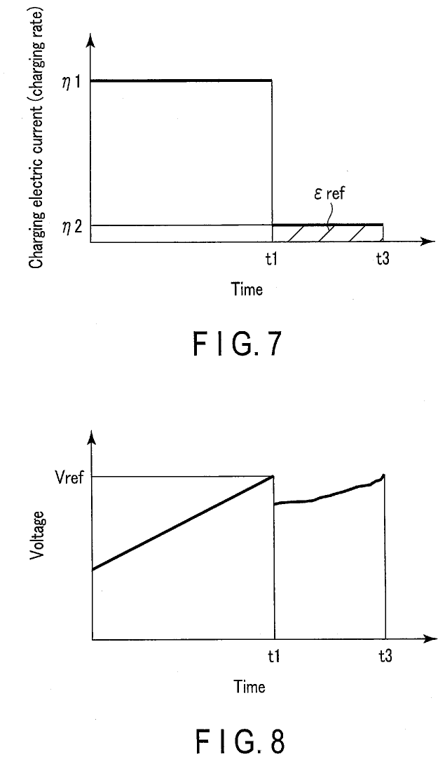

FIG. 7 shows an example of a change with time of an electric current flowing through the battery pack 4, in a case where the SOC variation between the plurality of aqueous battery cells 5 is corrected in the battery pack 4 by the method (charging method) of the above-described embodiment. FIG. 8 shows a change with time of the voltage of the battery pack 4, in a case where the electric current of the battery pack 4 changes with time as shown in the example of FIG. 7. In FIGS. 7 and 8, the abscissa indicates the time. Also, the ordinate in FIG. 7 indicates the charging electric current of the battery pack 4 by the charging rate, and the ordinate in FIG. 8 indicates the voltage of the battery pack 4. In this example shown in FIGS. 7 and 8, after the constant-current charging of the battery pack 4 is started at the first charging rate η1, the voltage V of the battery pack 4 reaches the reference voltage Vref at time t1. Then, at time t1, the constant-current charging at the first charging rate η1 is switched to the constant-current charging of the battery pack 4 at the second charging rate η2.

In the example shown in FIGS. 7 and 8, at time t3, the charged electric charge amount ε of the battery pack 4 from the start timing (from time t1) of the constant-current charging at the second charging rate η2 reaches the reference electric charge amount ε ref. At time t3, therefore, the charging of the battery pack 4 is terminated. Also, in the example shown in FIGS. 7 and 8, the charged electric charge amount ε input to the battery pack 4 during the constant-current charging at the second charging rate η2, that is, the charged electric charge amount input to the battery pack 4 from time t1 to time t3 is the reference electric charge amount ε ref. The reference electric charge amount ε ref is equivalent to the area of an obliquely hatched portion in FIG. 7.

The comparison between the comparative example shown in FIGS. 5 and 6 and the example of the embodiment shown in FIGS. 7 and 8 reveals that the reference electric charge amount ε ref in the example shown in FIGS. 7 and 8 is smaller than the above-described electric charge amount sa in the comparative example shown in FIGS. 5 and 6. When compared to, for example, the comparative example shown in FIGS. 5 and 6, therefore, this embodiment can reduce the charged electric charge amount to be input to the battery pack 4 during the correction of the SOC variation between the plurality of aqueous battery cells 5.

In this embodiment, the charged electric charge amount to be input to the battery pack 4 during the correction of the SOC variation is appropriately reduced, and this makes it possible to appropriately reduce the amount of a gas to be generated by electrolysis of water in the aqueous battery cell 5 having a high SOC among the plurality of aqueous battery cells 5. In addition, since the charged electric charge amount input to the battery pack 4 during the correction of the SOC variation is properly reduced as described above, deterioration of each aqueous battery cell 5 of the battery pack 4 can properly be suppressed.

In this embodiment, the second charging rate η2 is set at 0.01 C or more, so the aqueous battery cell 5 having a low SOC among the plurality of aqueous battery cells 5 of the battery pack 4 is appropriately charged by constant-current charging at the second charging rate η2. This appropriately corrects the SOC variation between the plurality of aqueous battery cells 5, and appropriately equalizes the SOCs in the plurality of aqueous battery cells 5. Also, by setting the second charging rate η2 at 0.05 C or less, even when constant-current charging of the battery pack 4 is performed at the second charging rate η2, the amount of a gas to be generated by electrolysis of water can properly be reduced in the aqueous battery cell 5 having a high SOC among the plurality of aqueous battery cells 5 of the battery pack 4.

In this embodiment, constant-current charging of the battery pack 4 is continued at the second charging rate 112 until the charged electric charge amount ε from the start timing of the constant-current charging at the second charging rate η2 reaches the reference electric charge amount ε ref. Then, in this embodiment, by setting the reference electric charge amount ε ref at 1% or more of the nominal capacity of the battery pack 4, the constant-current charging at the second charging rate η2 appropriately corrects the SOC variation between the plurality of aqueous battery cells 5, and appropriately equalizes the SOCs of the plurality of aqueous battery cells 5. Also, in this embodiment, by setting the reference electric charge amount ε ref at 5% or less of the nominal capacity of the battery pack 4, the amount of a gas to be generated by electrolysis of water in the battery pack 4 is adequately reduced while the constant-current charging is performed at the second charging rate η2.

In this embodiment, the SOC variation between the plurality of aqueous battery cells 5 is corrected as described above. This adequately corrects the SOC variation between the plurality of aqueous battery cells 5 while simplifying the configuration of the storage system 1 and reducing the charged electric charge amount input to the battery pack 4.

Also, in this embodiment, the reference voltage Vref as a reference for terminating constant-current charging at the first charging rate η1 is set based on the temperature of the battery pack 4. That is, the reference voltage Vref is decreased as the temperature of the battery pack 4 rises. In the battery pack 4, a voltage at which electrolysis of water occurs tends to decrease as the temperature rises. Therefore, by decreasing the reference voltage Vref as the temperature of the battery pack 4 rises, the rise of the voltage of the battery pack 4 is properly suppressed in a state in which, for example, constant-current charging is performed at the second charging rate η2. This further appropriately reduces the amount of a gas to be generated in the battery pack 4 by electrolysis of water, during the correction of the SOC variation between the plurality of aqueous battery cells 5.

In this embodiment, the SOC variation between the plurality of aqueous battery cells 5 is corrected in each battery pack 4, based on the condition that the difference ΔV between the maximum voltage Vmax that is highest of the voltages of the plurality of battery packs 4 of the storage unit 2 and the minimum voltage Vmin that is lowest of the voltages of the plurality of battery packs 4 is larger than 5% of the maximum voltage Vmax. Accordingly, the battery pack 4 having a high voltage among the plurality of battery packs 4 is not continuously used in a state in which electrolysis of water easily occurs. This makes it possible to effectively prevent deterioration of the storage unit 2 caused if the battery pack 4 in which electrolysis of water easily occurs is continuously used. That is, deteriorations of the storage unit 2 such as a reduction of the battery capacity and a rise of the resistance are adequately prevented.

### Application Example

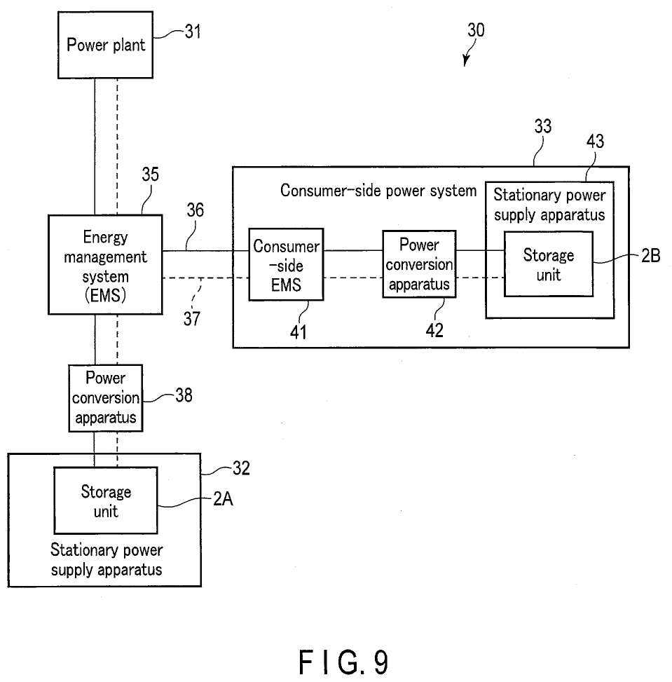

As an example in which the storage unit 2 as described above is mounted in the battery-mounted apparatus 6, an application example in which the storage unit 2 is mounted in a stationary power supply apparatus will be explained below. FIG. 9 shows an example of a system including the stationary power supply apparatus according to this application example. In this example shown in FIG. 9, a storage unit 2A is mounted in a stationary power supply apparatus 32, and a storage unit 2B is mounted in a stationary power supply apparatus 43. The stationary power supply apparatuses 32 and 43 are used in a system 30. The system 30 includes a power plant 31, the stationary power supply apparatus 32, a consumer-side power system 33, and an energy management system (EMS) 35. In addition, a power network 36 and a communication network 37 are formed in the system 30, and the power plant 31, the stationary power supply apparatus 32, the consumer-side power system 33, and the EMS 35 are connected across the power network 36 and the communication network 37. The EMS 35 performs control for stabilizing the whole system 30 by utilizing the power network 36 and the communication network 37.

The power plant 31 generates large-capacity electric power by using a fuel source such as thermal power or atomic power. The power plant 31 supplies the electric power across the power network 36. The storage unit 2A of the stationary power supply apparatus 32 can store the electric power supplied from the power plant 31. Also, the stationary power supply apparatus 32 can supply the electric power stored in the storage unit 2A across the power network 36. A power conversion apparatus 38 is installed in the system 30. The power conversion apparatus 38 includes a converter, an inverter, a transformer, and the like. Accordingly, the power conversion apparatus 38 can perform, for example, conversion between a direct current and an alternate current, conversion between alternate currents having different frequencies, and transformation (step-up and step-down). Therefore, the power conversion apparatus 38 can convert the electric power from the power plant 31 into electric power that can be stored in the storage unit 2A. In the example shown in FIG. 9, the power conversion apparatus 38 functions in the same manner as the driving circuit 11 described previously, in a case where, for example, the storage unit 2A is charged or discharged.

The consumer-side power system 33 includes, for example, a power system for a factory, a power system for a building, and a household power system. The consumer-side power system 33 includes a consumer-side EMS 41, a power conversion apparatus 42, and the stationary power supply apparatus 43. The consumer-side EMS 41 performs control for stabilizing the consumer-side power system 33.

The electric power from the power plant 31 and the electric power from the storage unit 2A are supplied to the consumer-side power system 33 across the power network 36. The storage unit 2B of the stationary power supply apparatus 43 can store the electric power supplied to the consumer-side power system 33. Also, the power conversion apparatus 42 includes, for example, a converter, an inverter, and a transformer, like the power conversion apparatus 38. Therefore, the power conversion apparatus 42 can perform, for example, conversion between a direct current and an alternate current, conversion between alternate currents having different frequencies, and transformation (step-up and step-down). Accordingly, the power conversion apparatus 42 can convert the electric power supplied to the consumer-side power system 33 into electric power that can be stored in the storage unit 2B. In the example shown in FIG. 9, the power conversion apparatus 42 functions in the same manner as the driving circuit 11 described previously, in a case where, for example, the storage unit 2B is charged or discharged.

Note that the electric power stored in the storage unit 2B can be used to, for example, charge a vehicle such as an electric automobile. A natural energy source can also be installed in the system 30. In this case, the natural energy source generates electric power by natural energy such as the wind power and the sunlight. The electric power is then supplied across the power network 36 from the natural energy source as well, in addition to the power plant 31.

In the example shown in FIG. 9, the current detection circuit 12, the voltage detection circuit 13, and the temperature sensor 15 described previously are mounted in each of the stationary power supply apparatuses 32 and 43, and the electric current, the voltage, the temperature, and the like of each of the plurality of battery packs 4 are detected in each of the storage units 2A and 2B. In addition, one or more of the EMS 35, a computer different from the EMS 35, a cloud server, and the like function as the above-described management apparatus 3 for managing the storage unit 2A, thereby correcting the SOC variation between the plurality of aqueous battery cells 5 in the battery pack 4 of the storage unit 2A, in the same manner as in the above-described embodiment. Likewise, one or more of the EMS 35, the consumer-side EMS 41, a computer different from the EMS 35 and the consumer0side EMS 41, a cloud server, and the like function as the above-described management apparatus 3 for managing the storage unit 2B, thereby correcting the SOC variation between the plurality of aqueous battery cells 5 in the battery pack 4 of the storage unit 2B, in the same manner as in the above-described embodiment.

### Verification Related to Embodiment

Verification related to the above-described embodiment was also conducted. The conducted verification will be explained below. In this verification, an aqueous battery cell (single cell) in which an electrode group having a stack structure was housed inside a laminate film was formed in the same manner as the aqueous battery cell 5 of the example shown in FIG. 2. In this aqueous battery cell, a positive electrode and a negative electrode were formed as follows.

In the positive electrode, a titanium sheet was used as a positive-electrode current collector. Also, as a positive-electrode active material, particles of a lithium-nickel-cobalt-manganese composite oxide having a composition represented by formula LiNi_{0.33}Co_{0.33}Mn_{0.34}O₂ as one type of a lithium-nickel-cobalt-manganese composite oxide were prepared. In addition, acetylene black (AB) as a carbonaceous material was used as an electro-conductive agent, and polyvinylidene fluoride (PVdF) as one type of a polymer resin was used as a binder. The lithium-nickel-cobalt-manganese composite oxide, acetylene black, and polyvinylidene fluoride were suspended at blending ratios of 90 mass %, 5 mass %, and 5 mass %, respectively, in a solvent of N-methylpyrrolidone (NMP) as one type of an organic solvent, thereby preparing a slurry. Then, the prepared slurry was applied on the both surfaces of the titanium sheet as a positive-electrode current collector. More specifically, the slurry was applied on the positive-electrode current collector except for a portion serving as a positive-electrode current collecting tab.

After the applied slurry was dried, the slurry was rolled by a roll press or the like, thereby forming positive-electrode active material-containing layers on the both surfaces of the titanium sheet. Then, a positive electrode was formed by drying the positive-electrode current collector and the positive-electrode active material-containing layers formed on the both surfaces of the positive-electrode current collector.

In the negative electrode, a zinc sheet was used as a negative-electrode current collector. Also, as a negative-electrode active material, particles of a lithium-titanium-containing composite oxide represented by formula Li₄Ti₅O₁₂ as one type of a lithium-titanium-containing composite oxide were prepared. In addition, acetylene black (AB) as a carbonaceous material was used as an electro-conductive agent, and polyvinylidene fluoride (PVdF) as one type of a polymer resin was used as a binder. The lithium-titanium-containing composite oxide, acetylene black, and polyvinylidene fluoride were suspended at blending ratios of 90 mass %, 5 mass %, and 5 mass %, respectively, in a solvent of N-methylpyrrolidone (NMP) as one type of an organic solvent, thereby preparing a slurry. Then, the prepared slurry was applied on the both surfaces of the zinc sheet as a negative-electrode current collector. More specifically, the slurry was applied on the negative-electrode current collector except for a portion serving as a negative-electrode current collecting tab.

After the applied slurry was dried, the slurry was rolled by a roll press or the like, thereby forming negative-electrode active material-containing layers on the both surfaces of the zinc sheet. Then, a negative electrode was formed by drying the negative-electrode current collector and the negative-electrode active material-containing layers formed on the both surfaces of the negative-electrode current collector.

The electrode group was formed to have a stack structure by alternately stacking four negative electrodes and three positive electrodes. In this electrode group, separators were interposed between the positive electrodes and the negative electrodes. As the separator, a porous film of polyethylene as one type of a synthetic resin film was used. The thickness of the porous film was 15 μm. In this separator, alumina particle layers as nonconductive particle layers were formed on the both surfaces of the porous film. The thickness of the alumina particle layer was 3 μm.

Subsequently, the formed electrode group was accommodated inside a container member formed by a laminate film. A metal layer of the laminate film was made of aluminum. In addition, the electrode group was impregnated with an aqueous electrolytic solution as an aqueous electrolyte. As this aqueous electrolytic solution, an electrolytic solution made of an aqueous solution prepared by dissolving lithium chloride (LiCl) as lithium salt was used. The concentration of lithium chloride in the electrolytic solution was set at 12 mol/L. This aqueous electrolytic solution prepared as described above was injected inside the container member from a liquid injection port, and the container member was liquid-tightly sealed by closing the liquid injection port.

In the verification, the battery capacity of the aqueous battery cell formed as described above was measured. As the aqueous battery cell itself, the lower-limit voltage was set at 1.8 V, and the upper-limit voltage was set at 2.6 V. Then, the battery capacity was measured in a 25° C. environment. In this measurement of the battery capacity, the aqueous battery cell was charged to the upper-limit voltage by constant-current charging at 0.5 C. The aqueous battery cell was discharged from the upper-limit voltage to the lower-limit voltage by constant-current discharging at 0.5 C. After that, a discharging capacity from the upper-limit voltage to the lower-limit voltage was measured as the battery capacity of the aqueous battery cell. The battery capacity of the aqueous battery cell was 200 mA·h. This 200 mA·h as the measured battery capacity was regarded as the nominal capacity of the aqueous battery cell.

In this verification, two above-described aqueous battery cells were formed, and each of the two formed aqueous battery cells was discharged to the lower-limit voltage, that is, to a completely discharged state, by constant-current discharging at 0.5 C. More specifically, the constant-current discharging was performed in a 25° C. environment. Then, after each of the two aqueous battery cells was discharged to the lower-limit voltage by the constant-current discharging, one of the two aqueous battery cells was charged to 10 mA·h. Subsequently, two aqueous battery cells one of which was charged to 10 mA·h were electrically connected in series, thereby forming a 2-series-connection structure of the aqueous battery cells. In the formed 2-series-connection structure, only one of the two aqueous battery cells was charged from the completely discharged state, so an SOC variation was produced between the two aqueous battery cells. Also, in this 2-series-connection structure, the aqueous battery cells were electrically connected in series. Therefore, 200 mAh was regarded as the nominal capacity like that of the aqueous battery cell.

In a single aqueous battery cell as described earlier, the lower-limit voltage was set at 1.8 V, and the upper-limit voltage was set at 2.6 V. In the formed 2-series-connection structure, therefore, the lower-limit voltage was set at 3.6 V, and the upper-limit voltage was set at 5.2 V. In the verification, the battery capacity of the formed 2-series connection structure was measured. The measurement of the battery capacity was performed in a 25° C. environment. In this measurement of the battery capacity, the 2-series-connection structure was charged to the upper-limit voltage (5.2 V) by constant-current charging at 0.5 C. Then, the 2-series-connection structure was discharged from the upper-limit voltage to the lower-limit voltage (3.6 V) by constant-current discharging at 0.5 C. After that, the discharge capacity from the upper-limit voltage to the lower-limit voltage was measured as the battery capacity of the 2-series-connection structure. The battery capacity of the 2-series-connection structure was 190 mA·h.

In Example 1, after the battery capacity of the 2-series-connection structure was confirmed as described above, constant-current charging at 0.5 C was performed on the 2-series-connection structure until the upper-limit voltage (5.2 V) was reached. Then, constant-current charging at 0.02 C was performed on the 2-series-connection structure in response to the arrival of the voltage of the 2-series-connection structure at the upper-limit voltage. This constant-current charging at 0.02 C was performed for 1 hr. That is, the charged electric charge amount of the 2-series-connection structure from the start timing of the 0.02-C constant-current charging was 2% of the nominal capacity of the 2-series-connection structure (aqueous battery cells). In Example 1, the SOC variation between the two aqueous battery cells in the 2-series-connection structure was corrected by performing the 0.02-C constant-current charging for 1 hr after the 0.5-C constant-current charging. The 0.5-C constant-current charging and the 0.02-C constant-current charging were performed in a 25° C. environment.

In Example 2, after the battery capacity of the 2-series-connection structure was confirmed, constant-current charging at 0.5 C was performed on the 2-series-connection structure until the upper-limit voltage (5.2 V) was reached, in the same manner as in Example 1. In Example 2, however, constant-current charging at 0.01 C was performed on the 2-series-connection structure in response to the arrival of the voltage of the 2-series-connection structure at the upper-limit voltage. This constant-current charging at 0.01 C was performed for 2 hrs. That is, the charged electric charge amount of the 2-series-connection structure from the start timing of the 0.01-C constant-current charging was 2% of the nominal capacity of the 2-series-connection structure (aqueous battery cells). In Example 2, the SOC variation between the two aqueous battery cells in the 2-series-connection structure was corrected by performing the 0.01-C constant-current charging for 2 hrs after the 0.5-C constant-current charging. The 0.5-C constant-current charging and the 0.01-C constant-current charging were performed in a 25° C. environment.

In Example 3, after the battery capacity of the 2-series-connection structure was confirmed, constant-current charging at 0.5 C was performed on the 2-series-connection structure until the upper-limit voltage (5.2 V) was reached, in the same manner as in Example 1. In Example 3, however, constant-current charging at 0.05 C was performed on the 2-series-connection structure in response to the arrival of the voltage of the 2-series-connection structure at the upper-limit voltage. This constant-current charging at 0.05 C was performed for 24 min. That is, the charged electric charge amount of the 2-series-connection structure from the start timing of the 0.05-C constant-current charging was 2% of the nominal capacity of the 2-series-connection structure (aqueous battery cells). In Example 3, the SOC variation between the two aqueous battery cells in the 2-series-connection structure was corrected by performing the 0.05-C constant-current charging for 24 min after the 0.5-C constant-current charging. The 0.5-C constant-current charging and the 0.05-C constant-current charging were performed in a 25° C. environment.

In Example 4, after the battery capacity of the 2-series-connection structure was confirmed, constant-current charging at 0.2 C was performed on the 2-series-connection structure until the upper-limit voltage (5.2 V) was reached. Then, constant-current charging at 0.02 C was performed on the 2-series-connection structure in response to the arrival of the voltage of the 2-series-connection structure at the upper-limit voltage. This constant-current charging at 0.02 C was performed for 1 hr. That is, the charged electric charge amount of the 2-series-connection structure from the start timing of the 0.02-C constant-current charging was 2% of the nominal capacity of the 2-series-connection structure (aqueous battery cells). In Example 4, the SOC variation between the two aqueous battery cells in the 2-series-connection structure was corrected by performing the 0.02-C constant-current charging for 1 hr after the 0.2-C constant-current charging. The 0.2-C constant-current charging and the 0.02-C constant-current charging were performed in a 25° C. environment.

In Example 5, after the battery capacity of the 2-series-connection structure was confirmed, constant-current charging at 1 C was performed on the 2-series-connection structure until the upper-limit voltage (5.2 V) was reached. Then, constant-current charging at 0.02 C was performed on the 2-series-connection structure in response to the arrival of the voltage of the 2-series-connection structure at the upper-limit voltage. This constant-current charging at 0.02 C was performed for 1 hr. That is, the charged electric charge amount of the 2-series-connection structure from the start timing of the 0.02-C constant-current charging was 2% of the nominal capacity of the 2-series-connection structure (aqueous battery cells). In Example 5, the SOC variation between the two aqueous battery cells in the 2-series-connection structure was corrected by performing the 0.02-C constant-current charging for 1 hr after the 1-C constant-current charging. The 1-C constant-current charging and the 0.02-C constant-current charging were performed in a 25° C. environment.

In Comparative Example 1, after the battery capacity of the 2-series-connection structure was confirmed, constant-current charging at 0.5 C was performed on the 2-series-connection structure until the upper-limit voltage (5.2 V) was reached, in the same manner as in Example 1. In Comparative Example 1, however, constant-voltage charging at the upper-limit voltage (5.2 V) was performed on the 2-series-connection structure in response to the arrival of the voltage of the 2-series-connection structure at the upper-limit voltage. This constant-voltage charging at the upper-limit voltage was performed for 1 hr. The charged electric charge amount of the 2-series-connection structure from the start timing of the constant-voltage charging at the upper-limit voltage was 8% of the nominal capacity of the 2-series-connection structure (aqueous battery cells). In Comparative Example 1, the SOC variation between the two aqueous battery cells in the 2-series-connection structure was corrected by performing the constant-voltage charging at the upper-limit voltage for 1 hr after the 0.5-C constant-current charging. The 0.5-C constant-current charging and the constant-voltage charging at the upper-limit voltage were performed in a 25° C. environment.

In Comparative Example 2, after the battery capacity of the 2-series-connection structure was confirmed, constant-current charging at 0.5 C was performed on the 2-series-connection structure until the upper-limit voltage (5.2 V) was reached, in the same manner as in Example 1. In Comparative Example 2, however, constant-current charging at 0.005 C was performed on the 2-series-connection structure in response to the arrival of the voltage of the 2-series-connection structure at the upper-limit voltage. This constant-current charging at 0.005 C was performed for 4 hrs. That is, the charged electric charge amount of the 2-series-connection structure from the start timing of the 0.005-C constant-current charging was 2% of the nominal capacity of the 2-series-connection structure (aqueous battery cells). In Comparative Example 2, the SOC variation between the two aqueous battery cells in the 2-series-connection structure was corrected by performing the 0.005-C constant-current charging for 4 hrs after the 0.5-C constant-current charging. The 0.5-C constant-current charging and the 0.005-C constant-current charging were performed in a 25° C. environment.

In Comparative Example 3, after the battery capacity of the 2-series-connection structure was confirmed, constant-current charging at 0.5 C was performed on the 2-series-connection structure until the upper-limit voltage (5.2 V) was reached, in the same manner as in Example 1. In Comparative Example 3, however, constant-current charging at 0.08 C was performed on the 2-series-connection structure in response to the arrival of the voltage of the 2-series-connection structure at the upper-limit voltage. This constant-current charging at 0.08 C was performed for 15 min. That is, the charged electric charge amount of the 2-series-connection structure from the start timing of the 0.08-C constant-current charging was 2% of the nominal capacity of the 2-series-connection structure (aqueous battery cells). In Comparative Example 3, the SOC variation between the two aqueous battery cells in the 2-series-connection structure was corrected by performing the 0.08-C constant-current charging for 15 min after the 0.5-C constant-current charging. The 0.5-C constant-current charging and the 0.08-C constant-current charging were performed in a 25° C. environment.

In Comparative Example 4, after the battery capacity of the 2-series-connection structure was confirmed, constant-current charging at 0.5 C was performed on the 2-series-connection structure until the upper-limit voltage (5.2 V) was reached, in the same manner as in Example 1. Then, constant-current charging at 0.02 C was performed on the 2-series-connection structure in response to the arrival of the voltage of the 2-series-connection structure at the upper-limit voltage. In Comparative Example 4, however, this constant-current charging at 0.02 C was performed for 21 min. That is, the charged electric charge amount of the 2-series-connection structure from the start timing of the 0.02-C constant-current charging was 0.7% of the nominal capacity of the 2-series-connection structure (aqueous battery cells). In Comparative Example 4, the SOC variation between the two aqueous battery cells in the 2-series-connection structure was corrected by performing the 0.02-C constant-current charging for 21 min after the 0.5-C constant-current charging. The 0.5-C constant-current charging and the 0.02-C constant-current charging were performed in a 25° C. environment.

In Comparative Example 5, after the battery capacity of the 2-series-connection structure was confirmed, constant-current charging at 0.5 C was performed on the 2-series-connection structure until the upper-limit voltage (5.2 V) was reached, in the same manner as in Example 1. Then, constant-current charging at 0.02 C was performed on the 2-series-connection structure in response to the arrival of the voltage of the 2-series-connection structure at the upper-limit voltage. In Comparative Example 5, however, this constant-current charging at 0.02 C was performed for 3 hrs. That is, the charged electric charge amount of the 2-series-connection structure from the start timing of the 0.02-C constant-current charging was 6% of the nominal capacity of the 2-series-connection structure (aqueous battery cells). In Comparative Example 5, the SOC variation between the two aqueous battery cells in the 2-series-connection structure was corrected by performing the 0.02-C constant-current charging for 3 hrs after the 0.5-C constant-current charging. The 0.5-C constant-current charging and the 0.02-C constant-current charging were performed in a 25° C. environment.

In the verification, the battery capacity of the 2-series-connection structure was measured after the SOC variation between the two aqueous battery cells was corrected as described above, for each of Examples 1 to 5 and Comparative Examples 1 to 5. This measurement of the battery capacity was performed in a 25° C. environment. In the measurement of the battery capacity, the 2-series-connection structure was charged to the upper-limit voltage (5.2 V) by constant-current charging at 0.5 C. Then, the 2-series-connection structure was discharged from the upper-limit voltage to the lower-limit voltage (3.6 V) by constant-current discharging at 0.5 C. After that, the discharged capacity from the upper-limit voltage to the lower-limit voltage was measured as the battery capacity of the 2-series-connection structure.

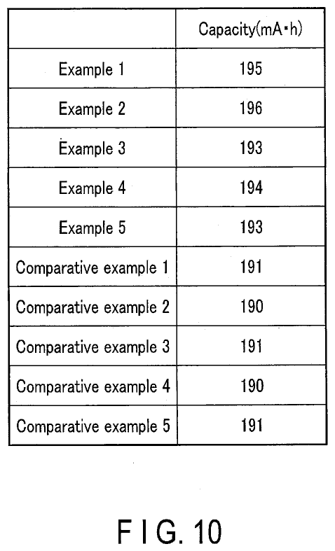

FIG. 10 shows the results of measurements of the battery capacities of the 2-series-connection structures, performed after the SOC variation between the two aqueous battery cells was corrected, in Examples 1 to 5 and Comparative Examples 1 to 5 of the verification related to the embodiment. As shown in FIG. 10, the battery capacities of the 2-series-connection structures measured after the SOC variation between the two aqueous battery cells was corrected were 195 mA·h, 196 mA·h, 193 mA·h, 194 mA·h, 193 mA·h, 191 mA·h, 190 mA·h, 191 mA·h, 190 mA·h, and 191 mA·h in Examples 1, 2, 3, 4, and 5 and Comparative Examples 1, 2, 3, 4, and 5, respectively.

In the 2-series-connection structure in which the SOC variation between the two aqueous battery cells is corrected as described above, the battery capacity measured after the correction has a value closer to 200 mA·h as the SOC variation between the two aqueous battery cells is corrected more appropriately, that is, as the SOCs of the two aqueous battery cells are closer to each other. Also, in the 2-series-connection structure, as the amount of a gas generated by electrolysis of water is reduced when the SOC variation between the two aqueous battery cells is corrected, the battery capacity measured after the correction becomes closer to 200 mA·h.

In the verification, the battery capacities measured after the SOC variation was corrected in Examples 1 to 5 were closer to 200 mA·h than the battery capacity measured after the SOC variation was corrected in Comparative Example 1. This demonstrates that the SOC variation is corrected more appropriately in a case where the SOC variation is corrected between the plurality of aqueous battery cells in the same manner as in the above-described embodiment, than in a case where constant-current charging is performed to the reference voltage Vref and constant-voltage charging is performed at the reference voltage Vref after that.

Also, in this verification, the battery capacities measured after the SOC variation was corrected in Examples 1 to 5 were closer to 200 mA·h than the battery capacities measured after the SOC variation was corrected in Comparative Examples 2 to 5. This demonstrates that the SOC variation is properly corrected by setting the second charging rate η2 from 0.01 C or more to 0.05 C or less, and setting the reference charge amount ε ref as a reference for terminating constant-current charging at the second charging rate η2 from 1% or more to 5% or less of the nominal capacity of the battery pack.

The differences from 200 mA·h produced in Examples 1 to 5 and Comparative Examples 1 to 5 are respectively 2.5%, 2%, 3.5%, 3%, and 3.5% in Examples 1, 2, 3, 4, and 5, and 4.5%, 5%, 4.5%, 5%, and 4.5% in Comparative Examples 1, 2, 3, 4, and 5, as the values of SOC. This charging method makes it possible not only to suppress the gas generation amount in the battery pack, but also to make battery pack extension unnecessary and suppress deterioration of the battery pack in a case where an aqueous electrolyte battery is incorporated into an apparatus. From the foregoing, the correction of the SOC variation in Examples 1 to 5 is largely improved in accuracy compared to the correction of SOC in Comparative Examples 1 to 5.

In at least one embodiment or example described above, in a case where the battery pack reaches the reference voltage by a constant-current charging at the first charging rate, constant-current charging is performed on the battery pack at the second charging rate that is lower than the first charging rate and is from 0.01 C or more to 0.05 C or less. Then, this constant-current charging at the second charging rate is continued until the charged electric charge amount from the start timing of the constant-current charging at the second charging rate reaches the reference electric charge amount set from 1% or more to 5% or less of the nominal capacity of the battery pack. This makes it possible to provide a charging method of a battery pack, a management method of a storage system, a management apparatus of a battery pack, a storage system, and a charging program of a battery pack, which can simplify the configuration, reduce the electric charge amount charged to the battery pack, and appropriately correct the SOC variation between a plurality of aqueous battery cells.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging method of a battery pack in which a plurality of aqueous battery cells each including an aqueous electrolyte, a positive electrode, and a negative electrode are electrically connected in series, comprising:
performing constant-current charging on the battery pack at a first charging rate until a voltage of the battery pack reaches a reference voltage;
performing constant-current charging on the battery pack at a second charging rate that is lower than the first charging rate and is from 0.01 C or more to 0.05 C or less, in response to arrival of the battery pack at the reference voltage by the constant-current charging at the first charging rate; and
continuing the constant-current charging at the second charging rate until a charged electric charge amount from a start timing of the constant-current charging at the second charging rate reaches a reference electric charge amount set from 1% or more to 5% or less of a nominal capacity of the battery pack.

2. The method according to claim 1, further comprising setting the reference voltage for the voltage of the battery pack based on a temperature of the battery pack.

3. The method according to claim 2, wherein in the setting of the reference voltage of the batter pack, the reference voltage is set to be lower as the temperature of the battery pack becomes higher.

4. The method according to claim 1, further comprising setting the reference voltage such that a value obtained by dividing the reference voltage by the number of serially connected aqueous battery cells in the battery pack is from 2.40 V or more to 2.75 V or less.

5. A management method of a storage system including a plural of the battery pack, comprising performing a charging method according to claim 1 on each of the plurality of battery packs, based on a condition that a difference between a maximum voltage that is highest of voltages of the plurality of battery packs and a minimum voltage that is lowest of the voltages of the plurality of battery packs is larger than 5% of the maximum voltage.

6. A management apparatus of a battery pack in which a plurality of aqueous battery cells each including an aqueous electrolyte, a positive electrode, and a negative electrode are electrically connected in series, comprising a control unit configured to:
perform constant-current charging on the battery pack at a first charging rate until a voltage of the battery pack reaches a reference voltage;
perform constant-current charging on the battery pack at a second charging rate that is lower than the first charging rate and is from 0.01 C or more to 0.05 C or less, in response to arrival of the battery pack at the reference voltage by the constant-current charging at the first charging rate; and
continue the constant-current charging at the second charging rate until a charged electric charge amount from a start timing of the constant-current charging at the second charging rate reaches a reference electric charge amount set from 1% or more to 5% or less of a nominal capacity of the battery pack.

7. A storage system comprising:
a management apparatus according to claim 6; and
the battery pack which includes the plurality of aqueous battery cells electrically connected in series, and charging of which is controlled by the control unit of the management apparatus.

8. The system according to claim 7, further comprising a battery-mounted apparatus in which the battery pack is mounted.

9. The system according to claim 7, wherein the battery pack includes a plural of the battery pack, and
based on a condition that a difference between a maximum voltage that is highest of voltages of the plurality of battery packs and a minimum voltage that is lowest of the voltages of the plurality of battery packs is larger than 5% of the maximum voltage, the control unit of the management apparatus sequentially performs, on each of the plurality of battery packs, the constant-current charging at the first charging rate until the reference voltage is reached, and the constant-current charging at the second charging rate until the reference electric charge amount is reached after the reference voltage is reached.

10. A non-transitory storage medium storing a charging program of a battery pack in which a plurality of aqueous battery cells each including an aqueous electrolyte, a positive electrode, and a negative electrode are electrically connected in series, wherein the charging program causes a computer to:
perform constant-current charging on the battery pack at a first charging rate until a voltage of the battery pack reaches a reference voltage;
perform constant-current charging on the battery pack at a second charging rate that is lower than the first charging rate and is from 0.01 C or more to 0.05 C or less, in response to arrival of the battery pack at the reference voltage by the constant-current charging at the first charging rate; and
continue the constant-current charging at the second charging rate until a charged electric charge amount from a start timing of the constant-current charging at the second charging rate reaches a reference electric charge amount set from 1% or more to 5% or less of a nominal capacity of the battery pack.
